(19) United States
(12) Patent Application Publication
(10) Pub. No.: US 2018/0159125 A1
(43) Pub. Date: Jun. 7, 2018

(54) COMPOSITION FOR NEGATIVE ELECTRODE ACTIVE MATERIALS, NEGATIVE ELECTRODE, NONAQUEOUS ELECTROLYTE RECHARGEABLE BATTERY, AND METHOD FOR PRODUCING COMPOSITION FOR NEGATIVE ELECTRODE ACTIVE MATERIALS

(71) Applicant: FUJI SILYSIA CHEMICAL LTD., Aichi (JP)

(72) Inventors: Mitsuhiro Kamimura, Aichi (JP); Yuki Ohara, Aichi (JP)

(73) Assignee: FUJI SILYSIA CHEMICAL LTD., Aichi (JP)

(21) Appl. No.: 15/579,267

(22) PCT Filed: Jun. 2, 2016
(86) PCT No.: PCT/JP2016/066408

§ 371 Date: Dec. 4, 2017

(30) Foreign Application Priority Data
Jun. 2, 2015 (JP) 2015-112197

(51) Int. Cl. H01M 4/38; H01M 4/134; H01M 4/133

(52) U.S. Cl. CPC H01M 4/386; H01M 2004/027; H01M 4/133; H01M 4/134

(57) ABSTRACT

A composition and a method for producing a composition are provided for negative electrode active materials, a negative electrode, and a nonaqueous electrolyte rechargeable battery, which are capable of improving cycle properties. The composition for negative electrode active materials includes a co-dispersion of a silica gel and a fine particulate carbon; and silicon particles contained in the co-dispersion, and so forth.

### CROSS-REFERENCE TO RELATED APPLICATION

This international application claims the benefit of Japanese Patent Application No. 2015-112197 filed on Jun. 2, 2015 with the Japan Patent Office, and the entire disclosure of Japanese Patent Application No. 2015-112197 is incorporated herein by reference.

### TECHNICAL FIELD

The present disclosure relates to a composition for negative electrode active materials, a negative electrode, a nonaqueous electrolyte rechargeable battery, and a method for producing the composition for negative electrode active materials.

### BACKGROUND ART

Along with remarkable development of electric vehicles, carry-on electronic devices, communication devices, and the like, a high-capacity nonaqueous electrolyte rechargeable battery (for example, lithium-ion rechargeable battery) is highly demanded in light of economic efficiency, downsizing and decreased weight of the devices, and so forth.

In order to allow the lithium-ion rechargeable battery to have the high capacity, investigation of negative electrode active materials is advancing. Instead of conventionally used carbon based materials such as graphite, proposed as the negative electrode active materials are silicon and the like, which are able to reversibly occlude and release more lithium ions (see Patent Document 1).

### PRIOR ART DOCUMENTS

### Patent Documents

Patent Document 1: Japanese Patent No. 336989

### SUMMARY OF THE INVENTION

### Problems to be Solved by the Invention

In case of using the negative electrode active materials including silicon, cycle properties of the lithium-ion rechargeable battery are not sufficient. Reasons for this can be explained as follows. Since the volume of a silicon particle drastically expands/contracts, when charging and discharging is repeated, decrease in the silicon particle volume accelerates, resulting in deterioration of the cycle properties.

One aspect of the present disclosure is to provide a composition for negative electrode active materials, a negative electrode, and a nonaqueous electrolyte rechargeable battery, which are capable of improving the cycle properties, and a method for producing the composition for negative electrode active materials.

### Means for Solving the Problems

A composition for negative electrode active materials as one aspect of the present disclosure comprises: a co-dispersion of a silica gel and a fine particulate carbon; and silicon particles contained in the co-dispersion. Use of the composition for negative electrode active materials of the present disclosure can improve cycle properties of a nonaqueous electrolyte rechargeable battery.

A negative electrode as one aspect of the present disclosure comprises the above-described composition for negative electrode active materials. Use of the negative electrode of the present disclosure can improve cycle properties of a nonaqueous electrolyte rechargeable battery.

A nonaqueous electrolyte rechargeable battery as one aspect of the present disclosure comprises the above-described negative electrode. The nonaqueous electrolyte rechargeable battery of the present disclosure excels in cycle properties.

A method for producing the composition for negative electrode active materials as one aspect of the present disclosure comprises a step of, in a mixture containing a silica sol, the fine particulate carbon, and the silicon particles, gelating the silica sol. According to the producing method of the present disclosure, the above-described composition for negative electrode active materials can be easily produced.

### BRIEF DESCRIPTION OF THE DRAWINGS

FIG. 1 is an explanatory diagram schematically showing a structure of a composition for negative electrode active materials.

FIG. 2 is a sectional view showing a structure of a lithium-ion rechargeable battery.

### EXPLANATION OF REFERENCE NUMERALS

1 . . . composition for negative electrode active materials, 3 . . . co-dispersion of silica gel and fine particulate carbon, 5 . . . silicon particle, 7 . . . pore, 11 . . . lithium-ion rechargeable battery, 13 . . . negative electrode, 15 . . . positive electrode, 17 . . . separator, 19, 21 . . . power collecting member, 23 . . . upper case, 25 . . . lower case, 27 . . . gasket

### MODE FOR CARRYING OUT THE INVENTION

Examples of the present disclosure will be described with reference to the drawings.

1. Composition for Negative Electrode Active Materials

A composition for negative electrode active materials of the present disclosure comprises a co-dispersion of silica gel and fine particulate carbon. Examples of the fine particulate carbon may include: carbon blacks, such as furnace black, channel black, acetylene black, and thermal black; graphites, such as natural graphite, artificial graphite, and expanded graphite; carbon fiber; carbon nanotube; and so forth.

Provided that the mass of the composition for negative electrode active materials is 100 parts by mass, it is preferable that the mass of the fine particulate carbon is within a range of 1 part to 50 parts by mass. In case of 1 part by mass or greater (preferably, 5 parts by mass or greater), electrical conductivity of the composition for negative electrode active materials is further improved. In case of 50 parts by mass or less, (preferably, 35 parts by mass or less), mechanical strength of the composition for negative electrode active materials is further improved.

It is preferable that the average particle size of the fine particulate carbon is within a range of 0.01 to 10 μm. If in this range, cycle properties of the composition for negative electrode active materials are further improved. The cycle properties of the composition for negative electrode active materials refer to the properties in which charge/discharge characteristics of the nonaqueous electrolyte rechargeable battery are unlikely to decrease even though charging and discharging is repeated in the nonaqueous electrolyte rechargeable battery using the composition for negative electrode active materials.

The average particle size of the fine particulate carbon can be measured by a laser diffraction method using a measuring instrument, SALD2200 (manufactured by Shimadzu Corporation).

The co-dispersion refers to a form in which colloidal particles forming the silica gel and the fine particulate carbon are co-dispersed together. The fine particulate carbon may exist in, between, or both in and between, the colloidal particles.

The composition for negative electrode active materials of the present disclosure is a porous body. It is preferable that the specific surface area of the composition for negative electrode active materials is within a range of 5 to 600 m²/g. If in this range, the cycle properties of the composition for negative electrode active materials are further improved.

It is preferable that the pore volume of the composition for negative electrode active materials is within a range of 0.1 to 2.0 ml/g. If in this range, the cycle properties of the composition for negative electrode active materials are further improved. Also, it is preferable that the average pore diameter of the composition for negative electrode active materials is within a range of 2 to 500 nm. If in this range, the cycle properties of the composition for negative electrode active materials are further improved. Values for the specific surface area, the pore volume, and the average pore diameter of the composition for negative electrode active materials were calculated based on results of a nitrogen absorption measurement.

The composition for negative electrode active materials of the present disclosure comprises the silicon particles. It is preferable that the average particle size of the silicon particle is within a range of 0.1 to 10 μm. If in this range, the cycle properties of the composition for negative electrode active materials are further improved. The average particle size of the silicon particle can be measured by a laser diffraction method. As a measuring instrument, SALD2200 (manufactured by Shimadzu Corporation) can be used.

Provided that the mass of the composition for negative electrode active materials is 100 parts by mass, it is preferable that the mass of the silicon particles is within a range from 5 parts to 90 parts by mass. If in this range, the cycle properties of the composition for negative electrode active materials are further improved. The silicon particles are included in the composition for negative electrode active materials, and preferably, they are dispersed in the composition for negative electrode active materials.

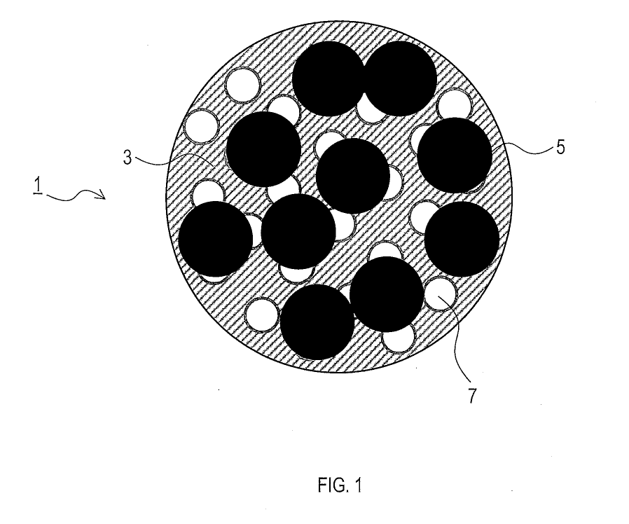

A structure of the composition for negative electrode active materials, for example, can be shown by a schematic diagram of FIG. 1. A composition for negative electrode active materials 1 comprises a co-dispersion 3 of silica gel and fine particulate carbon. Silicon particles 5 are contained in the co-dispersion 3. The co-dispersion 3 contains, for example, pores 7.

A reason why cycle properties of the nonaqueous electrolyte rechargeable battery are improved when the composition for negative electrode active materials is used can be explained as follows. Since the silicon particles are contained in the co-dispersion of silica gel and fine particulate carbon, expansion/contraction of the silicon particle volume is reduced at charging and discharging and the silicon particle is inhibited from becoming finer. Further, since an electrical conductive route is formed in the co-dispersion of silica gel and fine particulate carbon and the silicon particles are contained therein, even if the co-dispersion of silica gel and fine particulate carbon becomes finer, the electrical conductive route containing the silicon particles is maintained. Consequently, the cycle properties of the nonaqueous electrolyte rechargeable battery are improved.

2. Negative Electrode

A negative electrode of the present disclosure comprises the above-described composition for negative electrode active materials. A negative electrode active material may consist of the above-described composition for negative electrode active materials or may further comprise other components. The negative electrode may comprise known constituents in addition to the negative electrode active material described above.

3. Nonaqueous Electrolyte Rechargeable Battery

A nonaqueous electrolyte rechargeable battery of the present disclosure comprises the above-described negative electrode. Examples of the nonaqueous electrolyte rechargeable battery may include a lithium-ion rechargeable battery and so forth.

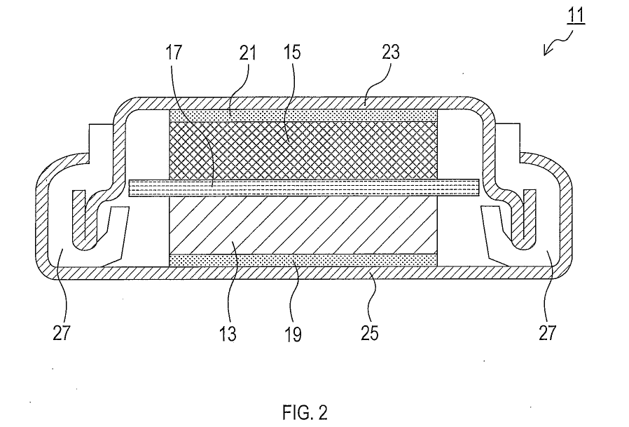

The lithium-ion rechargeable battery, for example, has a structure shown in FIG. 2. A lithium-ion rechargeable battery 11 comprises a negative electrode 13, a positive electrode 15, a separator 17, a power collecting member 19 on the negative electrode side, a power collecting member 21 on the positive electrode side, an upper case 23, a lower case 25, and a gasket 27. A container comprising the upper case 23 and the lower case 25 is filled with nonaqueous electrolyte.

4. Method for Producing Composition for Negative Electrode Active Materials

A method for producing the composition for negative electrode active materials of the present disclosure comprises a step of gelating silica sol in a mixture containing the silica sol, the fine particulate carbon, and the silicon particles. According to such a producing method, the above-described composition for negative electrode active materials can be produced.

The silica sol can be produced by (a) mixing an alkali metal silicate aqueous solution and acid or (b) hydrolyzing silicate ester or its polymer.

Examples of the alkali metal silicate may include lithium silicate, potassium silicate, and sodium silicate. Examples of the acid may include mineral acid. Examples of the mineral acid may include hydrochloric acid, sulfuric acid, nitric acid, carbonic acid, and so forth.

Examples of the silicate ester may include ethyl silicate, methyl silicate, their partial hydrolysate, and so forth. The silicate ester or its polymer can be hydrolyzed by adding acid or alkaline. Examples of the acid may include mineral acid. Examples of the mineral acid may include hydrochloric acid, sulfuric acid, nitric acid, carbonic acid, and so forth. Examples of the alkaline may include ammonia, sodium hydrate, lithium hydrate, and so forth.

The mixture including the silica sol, the fine particulate carbon, and the silicon particles, for example, can be produced by any one of the following methods (i) to (x).

(i) A first liquid including the fine particulate carbon and the silicon particles is prepared. Then, the alkali metal silicate aqueous solution is mixed with the acid so as to prepare a second liquid. The first liquid and the second liquid are mixed together before the second liquid is solated or before the second liquid is gelated although it has already been solated.

(ii) The fine particulate carbon and the silicon particles are mixed with the alkali metal silicate aqueous solution. Such a mixed liquid is mixed with the acid.

(iii) The fine particulate carbon and the silicon particles are mixed with the acid. Such a mixed liquid is mixed with the alkali metal silicate aqueous solution.

(iv) The fine particulate carbon is mixed with the alkali metal silicate aqueous solution so as to obtain a first mixed liquid. Also, the silicon particles are mixed with the acid so as to obtain a second mixed liquid. The first mixed liquid and the second mixed liquid are mixed together.

(v) The silicon particles are mixed with the alkali metal silicate aqueous solution so as to obtain a first mixed liquid. Also, the fine particulate carbon is mixed with the acid so as to obtain a second mixed liquid. The first mixed liquid and the second mixed liquid are mixed together.

(vi) A first liquid including the fine particulate carbon and the silicon particles is prepared. The silicate ester or its polymer is mixed with the acid or the alkaline so as to prepare a second liquid. The first liquid and the second liquid are mixed together before the second liquid is solated or before the second liquid is gelated although it has already been solated.

(vii) The fine particulate carbon and the silicon particles are mixed with the silicate ester or its polymer. Such a mixed liquid is mixed with the acid or the alkaline.

(viii) The fine particulate carbon and the silicon particles are mixed with the acid or the alkaline. Such a mixed liquid is mixed with the silicate ester or its polymer.

(ix) The fine particulate carbon is mixed with the silicate ester or its polymer so as to obtain a first mixed liquid. Also, the silicon particles are mixed with the acid or the alkaline so as to obtain a second mixed liquid. The first mixed liquid and the second mixed liquid are mixed together.

(x) The silicon particles are mixed with the silicate ester or its polymer so as to obtain a first mixed liquid. Also, the fine particulate carbon is mixed with the acid or the alkaline so as to obtain a second mixed liquid. The first mixed liquid and the second mixed liquid are mixed together.

In the method for producing the composition for negative electrode active materials of the present disclosure, a hydrothermal treatment after the gelating can be conducted. The hydrothermal treatment may be conducted before or after the composition for negative electrode active materials is dried. The temperature for the hydrothermal treatment can be, for example, 40 to 180° C. Also, the time of the hydrothermal treatment can be, for example, 1 to 100 hours.

Through the hydrothermal treatment, the specific surface area, the pore volume, and the average pore diameter of the composition for negative electrode active materials can be changed. The higher the temperature for the hydrothermal treatment is and/or the longer the time of the hydrothermal treatment is, the smaller the specific surface area is, the larger the pore volume is, and the larger the average pore diameter is.

In the method for producing the composition for negative electrode active materials of the present disclosure, surfactant agent may be used in order to improve dispersibility of the fine particulate carbon. Examples of the surfactant agent may include negative ion surfactant agent, positive ion surfactant agent, non-ionic surfactant agent, ampho-ionic surfactant agent, and so forth. The surfactant agent may be left in or removed from the composition for negative electrode active materials. Examples of a method for such removal may include a method of baking the composition for negative electrode active materials.

In the method for producing the composition for negative electrode active materials of the present disclosure, a commercially available water dispersion of the fine particulate carbon can be used. Examples of such a commercial product may include Lion paste W-310A, Lion paste W-311N, Lion paste W-356A, Lion paste W-376R, Lion paste W-370C (each manufactured by Lion Corporation), and so forth.

### Example 1

A commercially available product (Lion paste N-311), which is a solution with carbon black dispersed in water, was prepared. This solution contains, per 100 g thereof, 8 g of the carbon black. The average particle size of the carbon black contained in the solution is 0.1 μm.

10.3 g of silicon powder (average particle size: 0.6 μm, purity: 99.99% or more) was added to 74.5 g of the above-described solution so as to disperse the silicon powder in the solution. This solution is hereinafter referred to as a carbon black-silicon dispersion liquid.

On the other hand, 22 g of sulfuric acid (concentration: 12 N) and 78 g of sodium silicate (silica concentration: 25% by mass) were mixed together to obtain 100 g of silica sol.

The above-described silica sol was added to the above-described carbon black-silicon dispersion liquid and it was stirred so as to obtain a mixture. The entire mixture, then, changed to a solid matter (hydrogel). The hydrogel was cut into approximately 1 cm³ pieces and a batch cleaning was conducted using 1 L of ion exchange water five times.

After the cleaning was completed, the hydrogel was added to 1 L of ion exchange water. The pH value was adjusted to 9 using ammonia water. Then, the temperature was raised to 85° C. by heating and aging was conducted for 8 hours. Next, the hydrogel and the water were separated. After the hydrogel was dried at 180° C. for 10 hours, it was baked at 350° C. for 2 hours.

Consequently, 34.3 g of a complex whose silicon content is 30% by mass was obtained. The silicon content herein refers to the mass content (unit: % by mass) of the silicon particles per total volume of the complex.

20 g of the above-described complex was added to 100 ml of ion exchange water and the pH value was adjusted to 9 using ammonia water. Next, solid-liquid separation was conducted and hydrothermal polymerization was conducted to a solid matter under a temperature condition of 140° C. for 16 hours. Further, the solid matter was dried at 180° C. for 10 hours, and in the last step, it was pulverized with a ball mill so as to obtain a composition for negative electrode active materials. Physical properties of the obtained composition for negative electrode active materials were evaluated. Results of the evaluation are shown in Table 1. Average particle size in Table 1 refers to the average particle size of the silicon particle. Carbon content in Table 1 refers to the carbon content (unit: % by mass) of the composition for negative electrode active materials.

TABLE 1

| | Silicon | Average | Specific | Average pore | Pore | Carbon | Electrical |
|---|---|---|---|---|---|---|---|
| | content | particle size | surface area | diameter | volume | content | conductivity |
| | (% by mass) | (μm) | (m²/g) | (nm) | (ml/g) | (% by mass) | (S/cm) |
| Example 1 | 30 | 8.7 | 61 | 33 | 0.5 | 21 | 0.04 |
| Example 2 | 30 | 9 | 14 | 33 | 0.1 | 14 | 0.08 |
| Example 3 | 40 | 7.4 | 72 | 32 | 0.6 | 15 | 0.24 |
| Example 4 | 20 | 7.8 | 57 | 31 | 0.5 | 20 | 0.03 |
| Example 5 | 20 | 5.1 | 500 | 6 | 0.7 | 21 | 0.03 |

Methods of the evaluation are as follows.

Average particle size: The size was measured by a laser diffraction method. As a measuring instrument, SALD2200 (manufactured by Shimadzu Corporation) was used.

Specific surface area, Average pore diameter, Pore volume: The area, the diameter, and the volume were calculated based on results of a nitrogen absorption measurement. As a measuring instrument, BELSORP-max (manufactured by MicrotracBEL Corp., formerly BEL Japan, Inc.) was used.

Carbon content: The content was measured using an element analyzer, vario ELIII (manufactured by Elementar Analysensysteme GmbH).

Electrical conductivity: After adding a small amount of ion exchange water, 1.0 g of powder specimen was sufficiently mixed in an agate mortar. The mixed specimen was compression-molded under a condition of 1100 Kg/cm² using a tablet die machine so as to produce a tablet whose diameter is 10 mm. The produced tablet was fully dried using a hot plate set at 120° C. so as to obtain a sample whose thickness is 1.0 mm and diameter is 10.0 mm for electrical conductivity evaluation. The electrical conductivity relative to such sample for electrical conductivity evaluation was measured by a four-point probe method. As a measuring instrument, a resistivity meter, Loresta-GP (manufactured by Mitsubishi Chemical Analyteck Co.) was used.

### Example 2

In the same manner as that of the above-described Example 1, 34.3 g of a complex whose silicon content is 30% by mass was obtained. 20 g of the above-described complex was added to 100 ml of ion exchange water and the pH value was adjusted to 10 using sodium hydrate. Next, solid-liquid separation was conducted and hydrothermal polymerization was conducted to a solid matter under a temperature condition of 140° C. for 72 hours. Further, the solid matter was dried at 180° C. for 10 hours, and in the last step, it was pulverized with a ball mill so as to obtain a composition for negative electrode active materials. Physical properties of the obtained composition for negative electrode active materials were evaluated. Results of the evaluation are shown in Table 1 above.

### Example 3

A commercially available product (Lion paste N-311), which is a solution with carbon black dispersed in water, was prepared. 17.1 g of silicon powder (average particle size: 0.6 μm, purity: 99.99% or more) was added to 93 g of the above-described solution so as to disperse the silicon powder in the solution. This solution is hereinafter referred to as a carbon black-silicon dispersion liquid.

On the other hand, 12 g of sulfuric acid (concentration: 12 N) and 78 g of sodium silicate (silica concentration: 25% by mass) were mixed together to obtain 100 g of silica sol.

The above-described silica sol was added to the above-described carbon black-silicon dispersion liquid and it was stirred so as to obtain a mixture. The entire mixture, then, changed to a solid matter (hydrogel). The hydrogel was cut into approximately 1 cm³ pieces and a batch cleaning was conducted using 1 L of ion exchange water five times.

After the cleaning, the hydrogel was added to 1 L of ion exchange water and the pH value was adjusted to 9 using ammonia water. Then, the temperature was raised to 85° C. by heating and aging was conducted for 8 hours. Next, the hydrogel and the water were separated. After the hydrogel was dried at 180° C. for 10 hours, it was baked at 350° C. for 2 hours. Consequently, 42.5 g of a complex whose silicon content is 40% by mass was obtained.

20 g of the above-described complex was added to 100 ml of ion exchange water and the pH value was adjusted to 9 using ammonia water. Next, solid-liquid separation was conducted and hydrothermal polymerization was conducted to a solid matter under a temperature condition of 140° C. for 16 hours. Further, the solid matter was dried at 180° C. for 10 hours, and in the last step, it was pulverized with a ball mill so as to obtain a composition for negative electrode active materials. Physical properties of the obtained composition for negative electrode active materials were evaluated. Results of the evaluation are shown in Table 1 above.

### Example 4

A commercially available product (Lion paste N-311), which is a solution with carbon black dispersed in water, was prepared. 6 g of silicon powder (average particle size: 0.6 μm, purity: 99.99% or more) was added to 74.5 g of the above-described solution so as to disperse the silicon powder in the solution. This solution is hereinafter referred to as a carbon black-silicon dispersion liquid.

On the other hand, 12 g of sulfuric acid (concentration: 12 N) and 78 g of sodium silicate (silica concentration: 25% by mass) were mixed together to obtain 100 g of silica sol.

The above-described silica sol was added to the above-described carbon black-silicon dispersion liquid and it was stirred so as to obtain a mixture. The entire mixture, then, changed to a solid matter (hydrogel). The hydrogel was cut into approximately 1 cm³ pieces and a batch cleaning was conducted using 1 L of ion exchange water five times.

After the cleaning was completed, the hydrogel was added to 1 L of ion exchange water. The pH value was adjusted to 9 using ammonia water. Then, the temperature was raised to 85° C. by heating and aging was conducted for 8 hours. Next, the hydrogel and the water were separated. After the hydrogel was dried at 180° C. for 10 hours, it was baked at 350° C. for 2 hours. Consequently, 30 g of a complex whose silicon content is 20% by mass was obtained.

20 g of the above-described complex was added to 100 ml of ion exchange water and the pH value was adjusted to 9 using ammonia water. Next, solid-liquid separation was conducted and hydrothermal polymerization was conducted to a solid matter under a temperature condition of 140° C. for 16 hours. Further, the solid matter was dried at 180° C. for 10 hours, and in the last step, it was pulverized with a ball mill so as to obtain a composition for negative electrode active materials. Physical properties of the obtained composition for negative electrode active materials were evaluated. Results of the evaluation are shown in Table 1 above.

### Example 5

In the same manner as that of the above-described Example 4, 30 g of a complex whose silicon content is 20% by mass was obtained. The above-described complex was pulverized with a ball mill so as to obtain a composition for negative electrode active materials. Physical properties of the obtained composition for negative electrode active materials were evaluated. Results of the evaluation are shown in Table 1 above.

### Example 6

(1) Producing Negative Electrode and Lithium-Ion Rechargeable Battery

Negative electrodes and lithium-ion rechargeable batteries were manufactured using the compositions for negative electrode active materials produced in Examples 1 to 5 as follows.

100 parts by mass of the composition for negative electrode active materials, 5.7 parts by mass of styrene-butadiene rubber based biding agent, and 4.5 parts by mass of acetylene black (one example of conductivity aid) were mixed together. The mixture was suspended in a carboxymethyl cellulose aqueous solution to produce a paste. Such a paste was spread over a surface of 0.015 mm thick copper foil and dried. Then, a member with an area of 2 cm² was punched out from the copper foil to obtain the negative electrode.

The lithium-ion rechargeable battery (one example of the nonaqueous electrolyte rechargeable battery) was manufactured using the above-described negative electrode, an opposite electrode formed of lithium foil, a separator formed of 25 μm thick polyethylene porous film, and nonaqueous electrolyte. The nonaqueous electrolyte was obtained by dissolving lithium hexafluorophosphate at a concentration of 1 mol/L in a mixed liquid of ethylene carbonate and diethyl carbonate in a 1:1 (mass ratio).

(2) Charging and Discharging Measurement

A charging and discharging measurement of the lithium-ion rechargeable battery manufactured in (1) above was conducted as follows. The first cycle of charging and discharging was conducted at the ambient temperature of 25° C. With the current value firstly fixed at 0.2 C, the charging of the first cycle was conducted under a constant current condition until the voltage became 0.05 V. Further, the charging was continued until the current value declined to 0.05 C. 1 C refers to the current value with which full charge can be achieved for 1 hour. Next, the discharging of the first cycle was conducted. With the current value maintained at 0.2 C, the discharging of the first cycle was continued until the voltage relative to metal Li became 1.0 V.

Subsequently, 2 to 30 cycles of charging and discharging were conducted. A condition for the 2 to 30 cycles of charging and discharging was basically the same as that for the first cycle of charging and discharging except the current values at the time of the charging under the constant current value condition and at the time of the discharging, which were both 0.5 C.

Respective discharge capacities, C1 of the first cycle, C10 of the 10^{th} cycle, and C30 of the 30^{th} cycle, were calculated. Further, the capacity retention rate R (%) was defined by the following formula (1) and a value of the rate was calculated.

R=(C30/C10)×100 Formula (1)

C1, C10, C30, and the capacity retention rate R are shown in Table 2.

TABLE 2

| | C₁ | C₁₀ | C₃₀ | R |
|---|---|---|---|---|
| | (mAh/g) | (mAh/g) | (mAh/g) | (%) |
| Example 1 | 719 | 444 | 388 | 87 |
| Example 2 | 123 | 117 | 131 | 112 |
| Example 3 | 665 | 302 | 272 | 90 |
| Example 4 | 267 | 178 | 176 | 99 |
| Example 5 | 406 | 158 | 118 | 75 |

As shown in Table 2, the capacity retention rates R of the lithium-ion rechargeable batteries using the compositions for negative electrode active materials of Examples 1 to 5 were remarkably high. That is, the cycle properties of the compositions for negative electrode active materials of Examples 1 to 5, those of the negative electrodes comprising such compositions, and those of the lithium-ion rechargeable batteries comprising such negative electrodes were remarkably excellent.

1. A composition for negative electrode active materials, the composition comprising:
a co-dispersion of a silica gel and a fine particulate carbon; and silicon particles contained in the co-dispersion.

2. The composition for negative electrode active materials according to claim 1,
wherein a specific surface area of the composition for negative electrode active materials is within a range of 5 to 600 m²/g.

3. A negative electrode comprising the composition for negative electrode active materials according to claim 1.

4. A nonaqueous electrolyte rechargeable battery comprising the negative electrode according to claim 3.

5. A method for producing the composition for negative electrode active materials according to claim 1, the method comprising a step of, in a mixture comprising a silica sol, the fine particulate carbon, and the silicon particles, gelating the silica sol.

6. The method for producing the composition for negative electrode active materials according to claim 5,
wherein a hydrothermal treatment is conducted subsequent to the gelating.

7. The method for producing the composition for negative electrode active materials according to claim 5, the method further comprising producing the silica sol by (a) mixing an alkali metal silicate aqueous solution and an acid or (b) hydrolyzing a silicate ester or a polymer thereof.
